(19) United States
(12) Patent Application Publication
(10) Pub. No.: US 2024/0413936 A1
(43) Pub. Date: Dec. 12, 2024

(54) UPLINK LOSSLESS TRANSMISSION

(71) Applicant: QUALCOMM Incorporated, San Diego, CA (US)

(72) Inventors: Peng CHENG, Beijing (CN); Karthika PALADUGU, Hyderabad (IN); Ozcan OZTURK, San Diego, CA (US); Masato KITAZOE, Hachiouji-shi (JP); Hong CHENG, Basking Ridge, NJ (US)

(21) Appl. No.: 18/697,942

(22) PCT Filed: Dec. 10, 2021
(86) PCT No.: PCT/CN2021/137007

§ 371 Date: Apr. 2, 2024

(51) Int. Cl. H04L 1/1867; H04L 1/1607

(52) U.S. Cl. CPC H04L 1/188; H04L 1/1607; H04L 1/189

(57) ABSTRACT

Various aspects of the present disclosure generally relate to wireless communication. In some aspects, a user equipment (UE) may receive an indication to transmit a packet based at least in part on receiving a packet data convergence protocol (PDCP) status report during an active state of a timer, or based at least in part on an expiration of the timer. The UE may transmit the packet based at least in part on the indication. Numerous other aspects are described.

### CROSS-REFERENCE TO RELATED APPLICATION

This application is a 371 national stage of Patent Cooperation Treaty (PCT) Application No. PCT/CN2021/137007 filed on Dec. 10, 2021, entitled “UPLINK LOSSLESS TRANSMISSION,” which is hereby expressly incorporated by reference herein.

### FIELD OF THE DISCLOSURE

Aspects of the present disclosure generally relate to wireless communication and to techniques and apparatuses for uplink lossless transmission.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving an indication to transmit a packet based at least in part on receiving a packet data convergence protocol (PDCP) status report during an active state of a timer, or based at least in part on an expiration of the timer. The method may include transmitting the packet based at least in part on the indication.

Some aspects described herein relate to a method of wireless communication performed by a UE. The method may include transmitting a first set of one or more packets, of a plurality of packets, based at least in part on receiving an acknowledgement message. The method may include transmitting a second set of one or more packets, of the plurality of packets, based at least in part on receiving a PDCP status report.

Some aspects described herein relate to an apparatus for wireless communication performed by a UE. The apparatus may include a memory and one or more processors, coupled to the memory. The one or more processors may be configured to receive an indication to transmit a packet based at least in part on receiving a PDCP status report during an active state of a timer, or based at least in part on an expiration of the timer. The one or more processors may be configured to transmit the packet based at least in part on the indication.

Some aspects described herein relate to an apparatus for wireless communication performed by a UE. The apparatus may include a memory and one or more processors, coupled to the memory. The one or more processors may be configured to transmit a first set of one or more packets, of a plurality of packets, based at least in part on receiving an acknowledgement message. The one or more processors may be configured to transmit a second set of one or more packets, of the plurality of packets, based at least in part on receiving a PDCP status report.

Some aspects described herein relate to a non-transitory computer-readable medium that stores a set of instructions for wireless communication by a UE. The set of instructions, when executed by one or more processors of the UE, may cause the UE to receive an indication to transmit a packet based at least in part on receiving a PDCP status report during an active state of a timer, or based at least in part on an expiration of the timer. The set of instructions, when executed by one or more processors of the UE, may cause the UE to transmit the packet based at least in part on the indication.

Some aspects described herein relate to a non-transitory computer-readable medium that stores a set of instructions for wireless communication by a UE. The set of instructions, when executed by one or more processors of the UE, may cause the UE to transmit a first set of one or more packets, of a plurality of packets, based at least in part on receiving an acknowledgement message. The set of instructions, when executed by one or more processors of the UE, may cause the UE to transmit a second set of one or more packets, of the plurality of packets, based at least in part on receiving a PDCP status report.

Some aspects described herein relate to an apparatus for wireless communication. The apparatus may include means for receiving an indication to transmit a packet based at least in part on receiving a PDCP status report during an active state of a timer, or based at least in part on an expiration of the timer. The apparatus may include means for transmitting the packet based at least in part on the indication.

Some aspects described herein relate to an apparatus for wireless communication. The apparatus may include means for transmitting a first set of one or more packets, of a plurality of packets, based at least in part on receiving an acknowledgement message. The apparatus may include means for transmitting a second set of one or more packets, of the plurality of packets, based at least in part on receiving a PDCP status report.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a user plane protocol stack and a control plane protocol stack, in accordance with the present disclosure.

FIG. 4 is a diagram illustrating an example of path switching, in accordance with the present disclosure.

FIG. 5 is a diagram illustrating an example of packet data convergence protocol (PDCP) re-establishment and data recovery, in accordance with the present disclosure.

FIG. 6 is a diagram illustrating an example associated with uplink lossless transmission, in accordance with the present disclosure.

FIG. 7 is a diagram illustrating an example associated with uplink lossless transmission, in accordance with the present disclosure.

FIG. 8 is a diagram illustrating an example process associated with uplink lossless transmission, in accordance with the present disclosure.

FIG. 9 is a diagram illustrating an example process associated with uplink lossless transmission, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

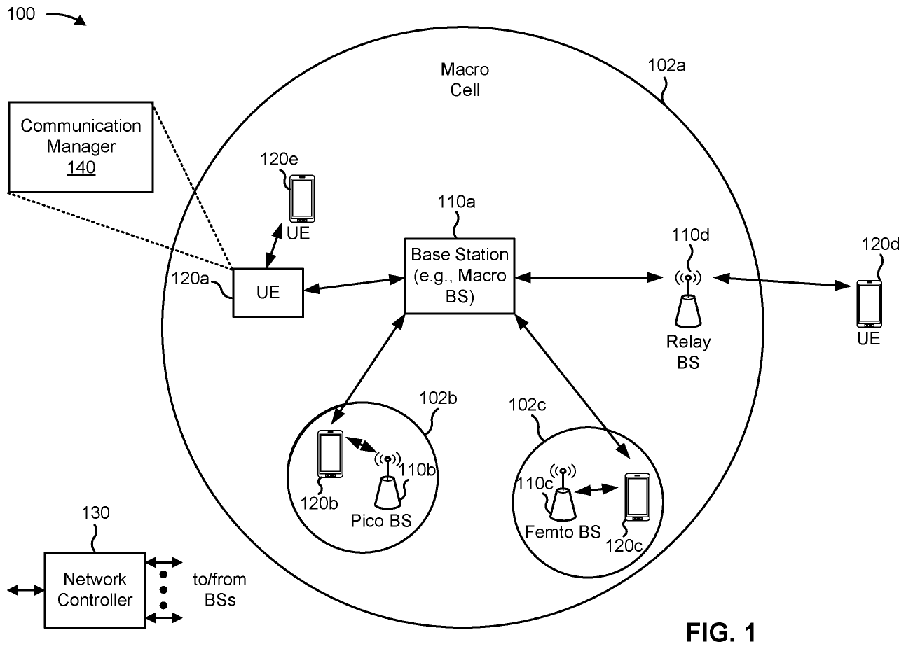

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication to transmit a packet based at least in part on receiving a packet data convergence protocol (PDCP) status report during an active state of a timer, or based at least in part on an expiration of the timer; and transmit the packet based at least in part on the indication. Additionally, or alternatively, the communication manager 140 may perform one or more other operations described herein.

In some aspects, as described in more detail elsewhere herein, the communication manager 140 may transmit a first set of one or more packets, of a plurality of packets, based at least in part on receiving an acknowledgement message; and transmit a second set of one or more packets, of the plurality of packets, based at least in part on receiving a PDCP status report. Additionally, or alternatively, the communication manager 140 may perform one or more other operations described herein.

As indicated above, FIG. 1 is provided as an example. Other examples may differ from what is described with regard to FIG. 1.

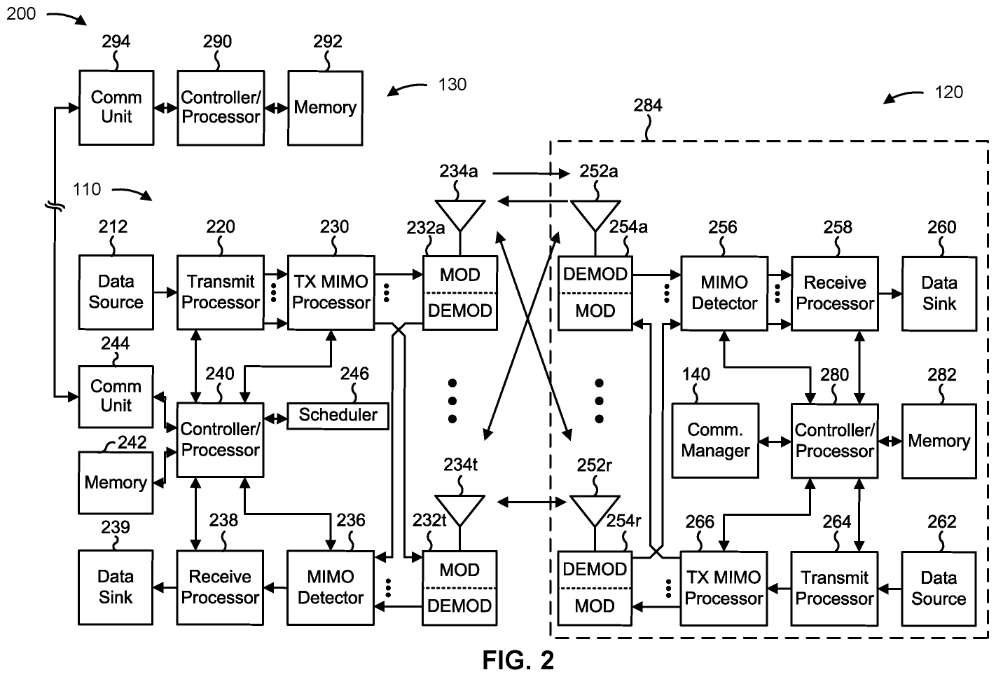

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

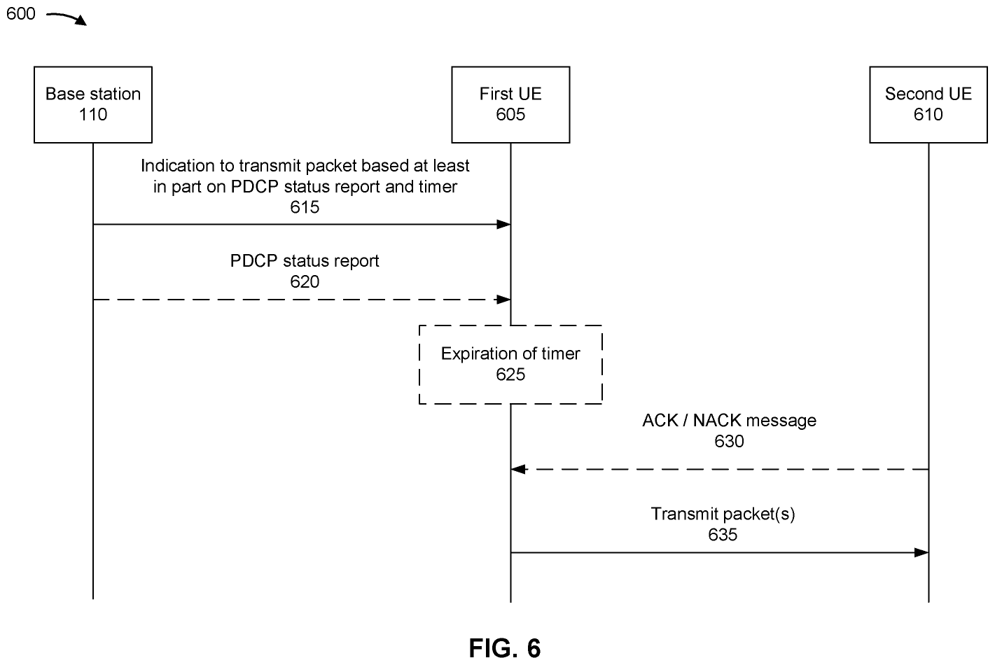

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-10).

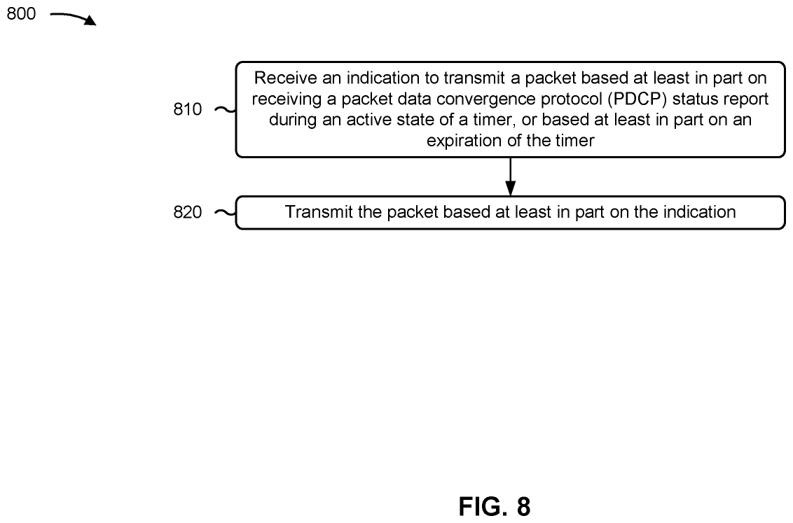

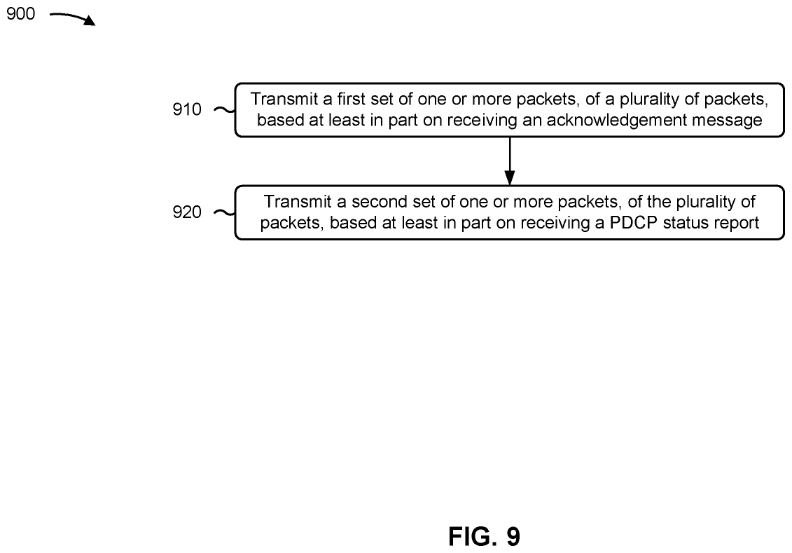

The controller/processor 240 of the base station 110, the controller/processor 280 of the UE 120, and/or any other component(s) of FIG. 2 may perform one or more techniques associated with uplink lossless transmission, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving an indication to transmit a packet based at least in part on receiving a packet data convergence protocol (PDCP) status report during an active state of a timer, or based at least in part on an expiration of the timer; and/or means for transmitting the packet based at least in part on the indication. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for transmitting a first set of one or more packets, of a plurality of packets, based at least in part on receiving an acknowledgement message; and/or means for transmitting a second set of one or more packets, of the plurality of packets, based at least in part on receiving a PDCP status report. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

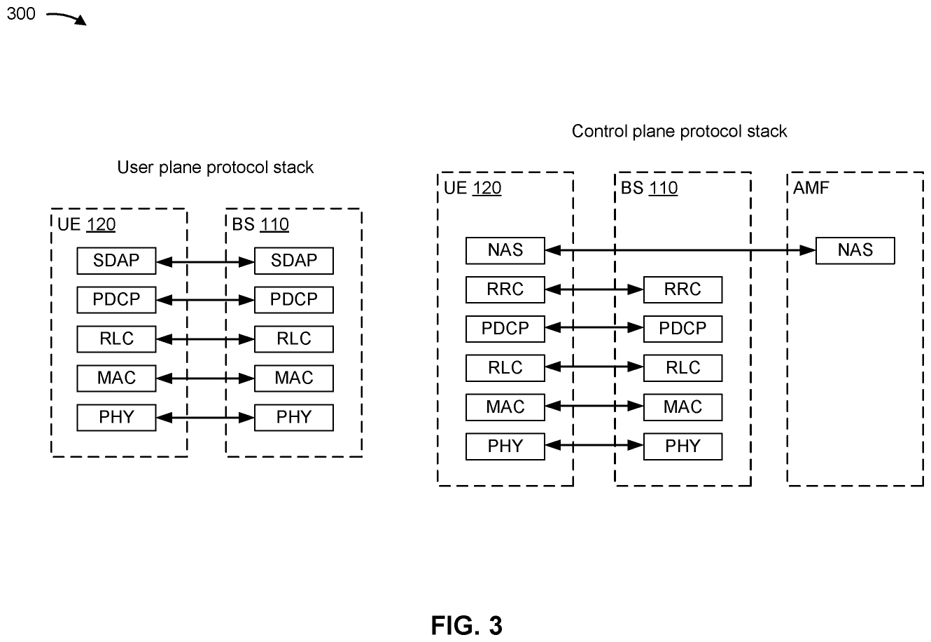

FIG. 3 is a diagram illustrating an example 300 of a user plane protocol stack and a control plane protocol stack for a base station 110 and a core network in communication with a UE 120, in accordance with the present disclosure.

On the user plane, the UE 120 and the BS 110 may include respective physical (PHY) layers, medium access control (MAC) layers, radio link control (RLC) layers, PDCP layers, and service data adaptation protocol (SDAP) layers. A user plane function may handle transport of user data between the UE 120 and the BS 110. On the control plane, the UE 120 and the BS 110 may include respective radio resource control (RRC) layers. Furthermore, the UE 120 may include a non-access stratum (NAS) layer in communication with an NAS layer of an access and management mobility function (AMF). The AMF may be associated with a core network associated with the BS 110, such as a 5G core network (5GC) or a next-generation radio access network (NG-RAN). A control plane function may handle transport of control information between the UE and the core network. Generally, a first layer is referred to as higher than a second layer if the first layer is further from the PHY layer than the second layer. For example, the PHY layer may be referred to as a lowest layer, and the SDAP/PDCP/RLC/MAC layer may be referred to as higher than the PHY layer and lower than the RRC layer. An application (APP) layer, not shown in FIG. 3, may be higher than the SDAP/PDCP/RLC/MAC layer. In some cases, an entity may handle the services and functions of a given layer (e.g., a PDCP entity may handle the services and functions of the PDCP layer), though the description herein refers to the layers themselves as handling the services and functions.

The RRC layer may handle communications related to configuring and operating the UE 120, such as: broadcast of system information related to the access stratum (AS) and the NAS; paging initiated by the 5GC or the NG-RAN; establishment, maintenance, and release of an RRC connection between the UE and the NG-RAN, including addition, modification, and release of carrier aggregation, as well as addition, modification, and release of dual connectivity; security functions including key management; establishment, configuration, maintenance, and release of signaling radio bearers (SRBs) and data radio bearers (DRBs); mobility functions (e.g., handover and context transfer, UE cell selection and reselection and control of cell selection and reselection, inter-RAT mobility); quality of service (QOS) management functions; UE measurement reporting and control of the reporting; detection of and recovery from radio link failure; and NAS message transfer between the NAS layer and the lower layers of the UE 120. The RRC layer is frequently referred to as Layer 3 (L3).

The SDAP layer, PDCP layer, RLC layer, and MAC layer may be collectively referred to as Layer 2 (L2). Thus, in some cases, the SDAP, PDCP, RLC, and MAC layers are referred to as sublayers of Layer 2. On the transmitting side (e.g., if the UE 120 is transmitting an uplink communication or the BS 110 is transmitting a downlink communication), the SDAP layer may receive a data flow in the form of a QoS flow. A QoS flow is associated with a QoS identifier, which identifies a QoS parameter associated with the QoS flow, and a QoS flow identifier (QFI), which identifies the QoS flow. Policy and charging parameters are enforced at the QoS flow granularity. A QoS flow can include one or more service data flows (SDFs), so long as each SDF of a QoS flow is associated with the same policy and charging parameters. In some cases, the RRC/NAS layer may generate control information to be transmitted and may map the control information to one or more radio bearers for provision to the PDCP layer.

The SDAP layer, or the RRC/NAS layer, may map QoS flows or control information to radio bearers. Thus, the SDAP layer may be said to handle QoS flows on the transmitting side. The SDAP layer may provide the QoS flows to the PDCP layer via the corresponding radio bearers. The PDCP layer may map radio bearers to RLC channels. The PDCP layer may handle various services and functions on the user plane, including sequence numbering, header compression and decompression (if robust header compression is enabled), transfer of user data, reordering and duplicate detection (if in-order delivery to layers above the PDCP layer is required), PDCP protocol data unit (PDU) routing (in case of split bearers), retransmission of PDCP service data units (SDUs), ciphering and deciphering, PDCP SDU discard (e.g., in accordance with a timer, as described elsewhere herein), PDCP re-establishment and data recovery for RLC acknowledged mode (AM), and duplication of PDCP PDUs. The PDCP layer may handle similar services and functions on the control plane, including sequence numbering, ciphering, deciphering, integrity protection, transfer of control plane data, duplicate detection, and duplication of PDCP PDUs.

The PDCP layer may provide data, in the form of PDCP PDUs, to the RLC layer via RLC channels. The RLC layer may handle transfer of upper layer PDUs to the MAC and/or PHY layers, sequence numbering independent of PDCP sequence numbering, error correction via automatic repeat requests (ARQ), segmentation and re-segmentation, reassembly of an SDU, RLC SDU discard, and RLC re-establishment.

The RLC layer may provide data, mapped to logical channels, to the MAC layer. The services and functions of the MAC layer include mapping between logical channels and transport channels (used by the PHY layer as described below), multiplexing/demultiplexing of MAC SDUs belonging to one or different logical channels into/from transport blocks (TBs) delivered to/from the physical layer on transport channels, scheduling information reporting, error correction through hybrid ARQ (HARQ), priority handling between UEs by means of dynamic scheduling, priority handling between logical channels of one UE by means of logical channel prioritization, and padding.

The MAC layer may package data from logical channels into TBs, and may provide the TBs on one or more transport channels to the PHY layer. The PHY layer may handle various operations relating to transmission of a data signal, as described in more detail in connection with FIG. 2. The PHY layer is frequently referred to as Layer 1 (L1).

On the receiving side (e.g., if the UE 120 is receiving a downlink communication or the BS 110 is receiving an uplink communication), the operations may be similar to those described for the transmitting side, but reversed. For example, the PHY layer may receive TBs and may provide the TBs on one or more transport channels to the MAC layer. The MAC layer may map the transport channels to logical channels and may provide data to the RLC layer via the logical channels. The RLC layer may map the logical channels to RLC channels and may provide data to the PDCP layer via the RLC channels. The PDCP layer may map the RLC channels to radio bearers and may provide data to the SDAP layer or the RRC/NAS layer via the radio bearers.

Data may be passed between the layers in the form of PDUs and SDUs. An SDU is a unit of data that has been passed from a layer or sublayer to a lower layer. For example, the PDCP layer may receive a PDCP SDU. A given layer may then encapsulate the unit of data into a PDU and may pass the PDU to a lower layer. For example, the PDCP layer may encapsulate the PDCP SDU into a PDCP PDU and may pass the PDCP PDU to the RLC layer. The RLC layer may receive the PDCP PDU as an RLC SDU, may encapsulate the RLC SDU into an RLC PDU, and so on. In effect, the PDU carries the SDU as a payload.

As described in more detail below, the UE may be configured to retransmit one or more packets (e.g., PDUs) based at least in part on a PDCP status report and an associated timer.

As indicated above, FIG. 3 is provided as an example. Other examples may differ from what is described with regard to FIG. 3.

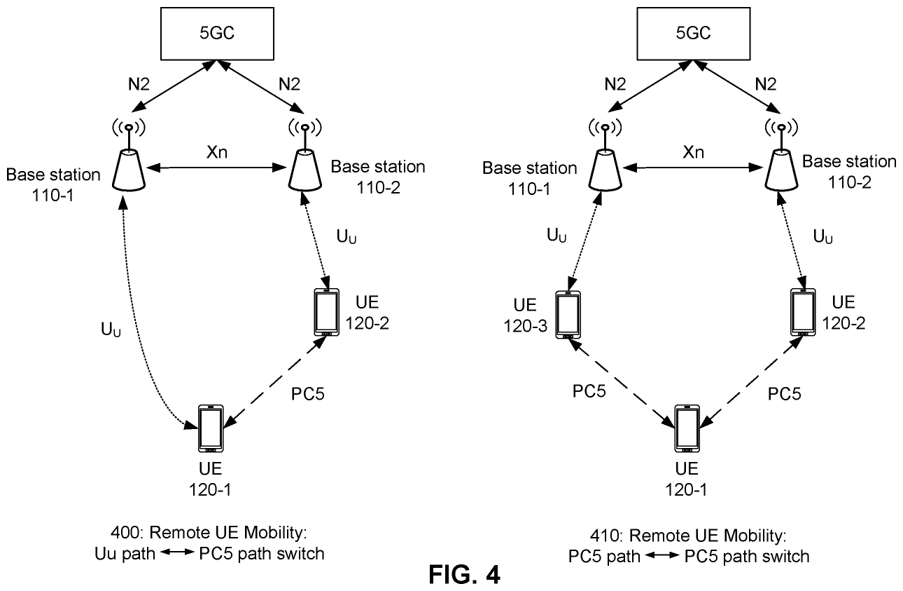

FIG. 4 is a diagram illustrating examples 400 and 410 of path switching, in accordance with the present disclosure.

As shown in the example 400, one or more base stations, such as the first base station 110-1 and the second base station 110-2, may communicate with a core network, such as the 5GC. The first base station 110-1 may communicate with a first UE, such as the first UE 120-1. The second base station 110-2 may communicate with a second UE, such as the second UE 120-2. The first base station 110-1 may communicate with the first UE 120-1, and the second base station 110-2 may communicate with the second UE 120-2, via a Uu interface. The first UE 120-1 may communicate with the second UE 120-2 via a PC5 interface.

As shown in the example 410, the first base station 110-1 and the second base station 110-2 may communicate with the 5GC. The first base station 110-1 may communicate with a third UE, such as the third UE 120-3. The third UE 120-3 may communicate with the first UE 120-1. The second base station 110-2 may communicate with the second UE 120-2. The first base station 110-1 may communicate with the third UE 120-3, and the second base station 110-2 may communicate with the second UE 120-2, via the Uu interface. The first UE 120-1 may communicate with the second UE 120-2, and with the third UE 120-3, via the PC5 interface.

In some cases, a path switching procedure (not shown) between the PC5 and Uu interfaces may include one or more of the following steps 1-8. The term “Remote UE” as used herein may refer to the UE 120-1, and the term “Relay UE” may refer to the UE 120-2 or the UE 120-3.

At step 1, a Uu measurement configuration and measurement report signaling procedure is performed to evaluate both a relay link measurement and a Uu link measurement. The measurement results from the Remote UE may be reported when configured reporting criteria are met. The SL relay measurement report may include at least a U2N (UE to network) Relay UE ID, a serving cell ID, and SL measurement quantity information. SL measurement quantity information may be SL-RSRP of the serving Relay UE, and if SL-RSRP is not available, SD-RSRP is used.

At step 2, the base station decides to switch the Remote UE to a direct Uu path.

At step 3, the base station sends an RRC Reconfiguration message to the U2N Remote UE. The U2N Remote UE stops UP and CP transmission via U2N Relay UE after reception of the RRCReconfiguration message from the base station.

At step 4, the U2N Remote UE synchronizes with the base station and performs a random access procedure.

At step 5, the UE (e.g., previous U2N Remote UE) sends an RRCReconfigurationComplete message to the base station via direct path, using the configuration provided in the RRC Reconfiguration message. From this step, the U2N Remote UE moves the RRC connection to the base station.

At step 6, the base station sends RRC′Reconfiguration message to the U2N Relay UE to reconfigure the connection between the U2N Relay UE and the base station. The RRCReconfiguration message to the U2N Relay UE can be sent any time after step 3 based on base station implementation (e.g., to release a Uu and PC5 RLC configuration for relaying, and a bearer mapping configuration between PC5 RLC and Uu RLC).

At step 7, either the U2N Relay UE or the U2N Remote UE can initiate the PC5 unicast link release (PC5-S). The timing to execute link release may be up to the UE implementation. The U2N Relay UE can execute PC5 connection reconfiguration to release PC5 RLC for relaying upon reception of RRC Reconfiguration by base station in step 6, or the UE (e.g., previous U2N Remote UE) can execute PC5 connection reconfiguration to release PC5 RLC for relaying upon reception of RRC Reconfiguration by base station in step 3.

At step 8, the data path is switched from indirect path to direct path between the UE (e.g., previous U2N Remote UE) and the base station. Step 8 can be executed in parallel or after step 5, which is independent of step 6 and step 7.

In some cases, a path switching procedure (not shown) between the Uu and PC5 interfaces may include one or more of the following steps 1-6.

At step 1, the U2N Remote UE reports one or multiple candidate U2N Relay UE(s) and legacy Uu measurements, after it measures/discovers the candidate U2N Relay UE(s). In some cases, the UE 120 may filter the appropriate U2N Relay UE(s) according to relay selection criteria before reporting. The UE may report only the U2N Relay UE candidate(s) that fulfill the higher layer criteria. In some cases, reporting can include at least the U2N Relay UE ID, the U2N Relay UE's serving cell ID, and SL measurement quantity SD-RSRP information. SL measurement quantity information can be SL-RSRP of the candidate Relay UE, and if SL-RSRP is not available, SD-RSRP is used.

At step 2, the base station decides to switch the U2N Remote UE to a target U2N Relay UE. Then, the base station sends an RRCReconfiguration message to the target U2N Relay UE, which can include at least Remote UE's local ID and L2 ID, Uu and PC5 RLC configuration for relaying, and bearer mapping configuration. In some cases, the base station may decide to perform a normal handover rather than a path switch to an indirect path.

At step 3, the base station sends the RRCReconfiguration message to the U2N Remote UE. The contents in the RRCReconfiguration message can include at least the U2N Relay UE ID, the PC5 RLC configuration for relay traffic, and the associated end-to-end radio bearer(s). The U2N Remote UE stops UP and CP transmission over Uu after reception of the RRCReconfiguration message from the base station.

At step 4, the U2N Remote UE establishes a PC5 connection with the target U2N Relay UE.

At step 5, the U2N Remote UE completes the path switch procedure by sending the RRCReconfigurationComplete message to the base station via the Relay UE.

At step 6, the data path is switched from direct path to indirect path between the U2N Remote UE and the base station.

The above path switching procedures are provided for example only. The UEs 120-1, 120-2, or 120-3, and the base stations 110-1 or 110-2 may be configured to perform any number of path switching procedures or steps, including some or all of the path switching procedures or steps described above, and/or other path switching procedures or steps not described herein.

The UE (e.g., the Remote UE) may be configured to retransmit one or more packets to ensure lossless transmission, such as during or after a path switching procedure, as described in more detail below.

As indicated above, FIG. 4 is provided as an example. Other examples may differ from what is described with regard to FIG. 4.

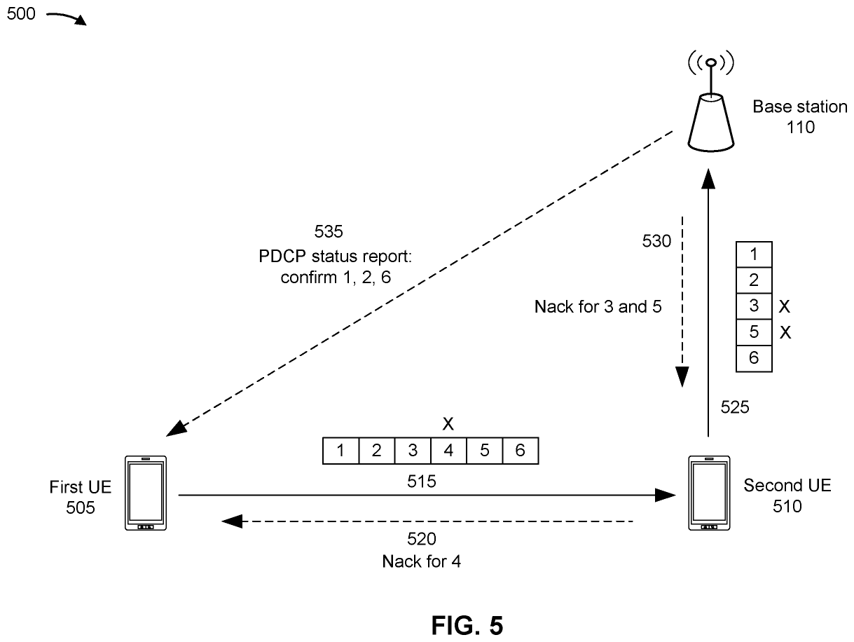

FIG. 5 is a diagram illustrating an example 500 of PDCP re-establishment and data recovery, in accordance with the present disclosure. A first UE, such as the first UE 505, may be configured to communicate with a second UE, such as the second UE 510. The first UE 505, and the second UE 510, may be configured to communicate with a base station, such as the base station 110. The first UE 505 and the second UE 510 may include some or all of the features of the UE 120. In some cases, the second UE 510 may be configured to relay communications from the first UE 505 to the base station 110. At least some of the communications described below may be performed during a path switching procedure, or after a path switching procedure.

As shown in connection with reference number 515, the first UE 505 may transmit, and the second UE 510 may receive, a communication that includes packets 1, 2, 3, 4, 5, 6.

As shown in connection with reference number 520, the second UE 510 may transmit, and the first UE 505 may receive, an indication that packet 4 was not received by the second UE 510. For example, the second UE 510 may transmit a negative acknowledgement (NACK) message associated with packet 4. The NACK message may indicate that packet 4 was not received, or that packet 4 was received with an error.

As shown in connection with reference number 525, the second UE 510 may transmit, and the base station 110 may receive, a communication that includes packets 1, 2, 3, 5, 6. The second UE 510 may not transmit packet 4, since packet 4 was not received by the second UE 510.

As shown in connection with reference number 530, the base station 110 may transmit, and the second UE 510 may receive, an indication that packets 3 and 5 were not received by the base station 110. For example, the base station 110 may transmit a NACK message associated with packets 3 and 5. The NACK message may indicate that packets 3 and 5 were not received, or that packets 3 and 5 were received with one or more errors.

As shown in connection with reference number 535, the base station 110 may transmit, and the first UE 505 may receive, a PDCP status report. The PDCP status report may indicate that packets 1, 2, and 6 were received by the base station 110.

In some cases, the PDCP procedure (e.g., sending the PDCP status report) may be an end-to-end procedure. For example, the first UE 505 may communicate directly with the base station 110. In contrast, the RLC procedure may be a hop-by-hop procedure. For example, communications between the first UE 505 and the base station 110 may be relayed by the second UE 510. Thus, it is possible that a packet is confirmed as being received by the second UE 510, but is not received by the base station 110. As described above, the NACK message associated with the RLC procedure may indicate that packet 4 was not received by the second UE 510, but the PDCP status report from the base station 110 may indicate that only packets 1, 2, and 6 were received by the base station 110 (e.g., packets 3, 4, and 5 were not received by the base station 110).

In some cases, the first UE 505 may be configured to retransmit one or more of the packets. In some cases, the first UE 505 may discard the PDCP packets that were confirmed by the PDCP status report (e.g., packets 1, 2, and 6).

In some cases, the retransmission of the one or more packets may occur during a PDCP re-establishment procedure, or a PDCP data recovery procedure. If the PDCP re-establishment procedure is initiated, the first UE 505 may re-transmit all remaining PDCP packets, starting from the first packet that is not confirmed by the RLC. For example, the first UE 505 may retransmit packet 4 and 5, while packet 3 may be lost. In contrast, if the PDCP data recovery is initiated, the first UE 505 may re-transmit only the remaining PDCP packets that are not confirmed by the RLC. For example, the first UE 505 may retransmit packet 4, while packets 3 and 5 may be lost.

As described above, the first UE may not be able to accurately determine which packets of a communication the first UE needs to retransmit. In some cases, the first UE may rely on lower layer signaling (e.g., from the second UE) for determining which packets (if any) need to be retransmitted. However, as described above, the lower layer signaling may not accurately reflect the packets that were received by the base station. In some cases, the first UE may retransmit all packets which are not confirmed as being received in the PDCP status report. In this case, the first UE may wait for the PDCP status report before making any retransmissions. However, the first UE may be able to determine when, or if, the base station will transmit the PDCP status report. Thus, the first UE may experience a delay in retransmitting the dropped packets, or may fail to retransmit the dropped packets at all (e.g., in the example that the base station does not send a PDCP status report). Thus, the first UE may not be able to ensure lossless transmission.

Techniques and apparatuses are described herein for uplink lossless transmission, such as uplink lossless transmission during an L2 relay path switch. In some aspects, a UE may receive an indication to transmit (e.g., retransmit) a packet based at least in part on receiving a PDCP status report during an active state of a timer, or based at least in part on an expiration of the timer. For example, the UE may receive an indication to retransmit the packet during the active state of the timer, if the PDCP status report is received during the active state of the timer, or to retransmit the packet after the expiration of the timer, if the PDCP status report is not received during the active state of the timer. The UE may retransmit the packet in accordance with the indication.

As described above, the UE may not be able to ensure lossless transmission of a communication during a path switching procedure (e.g., a switch between the Uu and PC5 interfaces). For example, the UE may receive an indication from a second UE (e.g., a relay UE) that certain packets of the communication were received by the second UE. However, the UE may not be able to determine whether those packets were actually delivered to the base station. The techniques and apparatuses described herein may enable the UE to retransmit packets according to the PDCP status report and an associated timer, thereby decreasing the likelihood of a packet being dropped or otherwise lost.

In some aspects, the UE may transmit a first set of one or more packets, of a plurality of packets, based at least in part on receiving an acknowledgement message, and may transmit a second set of one or more packets, of the plurality of packets, based at least in part on receiving a PDCP status report. The first set of packets may include all packets that were not received by a second UE, as indicated in the acknowledgement message. The second set of packets may include all packets that were not received by the base station, as indicated in the PDCP status report. In some aspects, the UE may transmit (e.g., retransmit) all packets of a communication that were not received by the base station. In some aspects, the UE may transmit only the packets that were not received by the base station, and that were not included in the first set of packets.

As described above, the UE may not be able to ensure lossless transmission of a communication during a path switching procedure (e.g., a switch between the Uu and PC5 interfaces). The techniques and apparatuses described herein may enable the UE to perform a first retransmission of a set of packets that were indicated by the second UE as not being received during the prior communication, and to perform a second retransmission of a set of packets that were indicated by the base station as not being received during the prior communication. Thus, the likelihood of a packet being lost, corrupted, or dropped, is reduced.

As indicated above, FIG. 5 is provided as an example. Other examples may differ from what is described with regard to FIG. 5.

FIG. 6 is a diagram illustrating an example 600 of uplink lossless transmission, in accordance with the present disclosure. A first UE, such as the first UE 605, may communicate with a second UE, such as the second UE 610. The first UE 605 and/or the second UE 610 may include some or all of the features of the UE 120. The first UE 605 and/or the second UE 610 may communicate with a base station, such as the base station 110.

As shown in connection with reference number 615, the base station 110 may transmit, and the first UE 605 may receive, an indication to transmit one or more packets based at least in part on receiving a PDCP status report during an active state of a timer, or based at least in part on an expiration of the timer. In some aspects, the indication may indicate for the first UE 605 to transmit the one or more packets during the active state of the timer, if the PDCP status report is received during the active state of the timer, or to transmit the one or more packets based at least in part on the expiration of the timer, if the PDCP status report is not received during the active state of the timer. For example, the indication may indicate for the first UE 605 to retransmit the one or more packets, and to stop the timer, if the PDCP status report is received during the active state of the timer. Additionally, or alternatively, the indication may indicate for the first UE 605 to retransmit the one or more packets according to a legacy procedure (e.g., based at least in part on an ACK or NACK message from the second UE 610) if the timer expires prior to the first UE 605 receiving the PDCP status report from the base station 110.

In some aspects, the indication to transmit the one or more packets may be transmitted and received via an RRC message. For example, the indication may be an RRCReconfigurationWithSync message that is used to trigger an indirect to direct (e.g., PC5 to Uu) path switch. In some aspects, the first UE 605 may be configured to initiate the timer based at least in part on receiving the indication (e.g., the RRC message).

In some aspects, the indication to transmit the one or more packets may be received as part of a path switching procedure. For example, the indication to transmit the one or more packets may be received as part of the PDCP re-establishment procedure, or the PDCP data recovery procedure, described above. In some aspects, the first UE 605 may be configured to initiate the timer based at least in part on receiving the initiation of the PDCP re-establishment procedure, or the initiation of the PDCP data recovery procedure.

In some aspects, the indication to transmit the one or more packets may be an indication to retransmit the one or more packets. As described above, the first UE 605 may transmit, to the second UE 610, a communication (e.g., a prior communication) that includes a plurality of packets. The second UE 610 may be configured to relay the communication, or a portion of the communication, to the base station 110. The first UE 605 may not be in communication with the base station 110. For example, the first UE 605 may be out of a communication range of the base station 110, or may not be authorized to communicate directly with the base station 110. In some aspects, the second UE 610 may transmit, to the first UE 605, a negative acknowledgement (NACK) message indicating that a particular packet, of the plurality of packets, was not received by the second UE 610. The second UE 610 may be configured to relay the prior communication to the base station 110. However, since the particular packet was not received by the second UE 610, the relayed communication may not include the particular packet.

As shown in connection with reference number 620, the base station 110 may transmit, and the first UE 605 may receive, the PDCP status report. The PDCP status report may indicate one or more packets, of the plurality of packets, that were received by the base station 110 (e.g., from the relayed communication). The PDCP status report may not indicate the particular packet, since second UE 610 did not transmit the particular packet to the base station 110. Additionally, or alternatively, the PDCP status report may not indicate one or more other packets, such as packets that were lost during the transmission from the second UE 610 to the base station 110.

In some aspects, the PDCP status report may be received prior to the expiration of the timer. The first UE 605 may be configured to stop the timer based at least in part on receiving the PDCP status report.

As shown in connection with reference number 625, the timer may expire. For example, the first UE 605 may detect an expiration of the timer, or may otherwise determine that the timer has expired. In some aspects, the timer may expire prior to the first UE 605 receiving the PDCP status report. In some aspects, the first UE 605 may be configured to stop the timer based at least in part on an initiation of an RRC re-establishment procedure.

As shown in connection with reference number 630, the second UE 610 may transmit, and the first UE 605 may receive, an acknowledgement message. In some aspects, the acknowledgement message may be a lower layer message indicating that one or more packets were not received in the communication from the first UE 605 to the second UE 610. The acknowledgement message may be an ACK message indicating which packets were received by the second UE 610. Additionally, or alternatively, the acknowledgement message may be a NACK message indicating which packets were not received by the second UE 610.

As shown in connection with reference number 635, the first UE 605 may transmit, and the second UE 610 may receive, one or more packets. The one or more packets may be transmitted based at least in part on the indication. For example, the one or more packets may include packets that were not received by the base station 110, in the case that the PDCP status report is received by the first UE 605, from the base station 110, prior to the expiration of the timer, or may include one or more packets that were indicated in the ACK or NACK message, received from the second UE 610, in the case that the timer expires before the PDCP status report is received by the first UE 605.

In some aspects, the first UE 605 may receive the PDCP status report from the base station 110 during the active state of the timer. In this case, the first UE 605 may transmit the one or more packets, to the second UE 610, based at least in part on the PDCP status report. For example, the first UE 605 may retransmit all packets that are not indicated in the PDCP status report as having been received by the base station 110. As described above, the second UE 610 may relay a first communication, from the first UE 605 to the base station 110, that includes packets 1, 2, 3, 4, 5, 6. The base station 110 may receive packets 1, 2, and 6. Packets 3, 4, and 5 may have been lost, corrupted, or otherwise dropped during the transmission to the base station 110. For example, the one or more packets may have been dropped during the transmission from the first UE 605 to the second UE 610, or during the transmission from the second UE 610 to the base station 110. The PDCP status report may indicate that packets 1, 2, and 6 were received by the base station 110. Alternatively, the PDCP status report may indicate that packets 3, 4, and 5 were not received by the base station 110. In this example, the first UE 605 may retransmit the one or more packets (e.g., packets 3, 4, and 5) to the second UE 610.

In some aspects, the timer may expire prior to the first UE 605 receiving the PDCP status report. In this case, the first UE 605 may be configured to transmit (e.g., retransmit) one or more packets in accordance with a prior configuration (e.g., a legacy configuration) of the first UE 605. In some aspects, the first UE 605 may receive, from the second UE 610, after the expiration of the timer, an indication of one or more packets that were not received by the second UE 610. The indication may be included in a lower layer message. For example, the first UE 605 may receive an ACK message, after the expiration of the timer, indicating that packets 1, 2, 3, 5, and 6 were received by the second UE 610. Alternatively, the first UE 605 may receive a NACK message, after the expiration of the timer, indicating that packet 4 was not received by the second UE 610. Thus, the first UE 605 may retransmit the one or more packets (e.g., packet 4) to the second UE 610.

In some aspects, the first UE 605 may determine that the indication includes one or more errors, or that the indication was not received by the first UE 605. In this case, the first UE 605 may be configured to retransmit one or more packets based at least in part on the lower layer message, such as the ACK message, or the NACK message, received from the second UE 610.

As described above, the first UE 605 may not be able to ensure lossless transmission of a communication during a path switching procedure (e.g., a switch between the Uu and PC5 interfaces). For example, the first UE 605 may receive an indication from the second UE 610 that certain packets of the communication were received by the second UE 610. However, the first UE 605 may not be able to determine whether those packets were actually delivered to the base station 110. The techniques and apparatuses described herein may enable the first UE 605 to retransmit packets according to the PDCP status report and an associated timer, thereby decreasing the likelihood of a packet being dropped or otherwise lost, and preventing the first UE 605 from delaying the retransmission of the one or more packets, or failing to retransmit the one or more packets, if the base station 110 takes too long to send the PDCP status report, or fails to send the PDCP status report at all.

As indicated above, FIG. 6 is provided as an example. Other examples may differ from what is described with regard to FIG. 6.

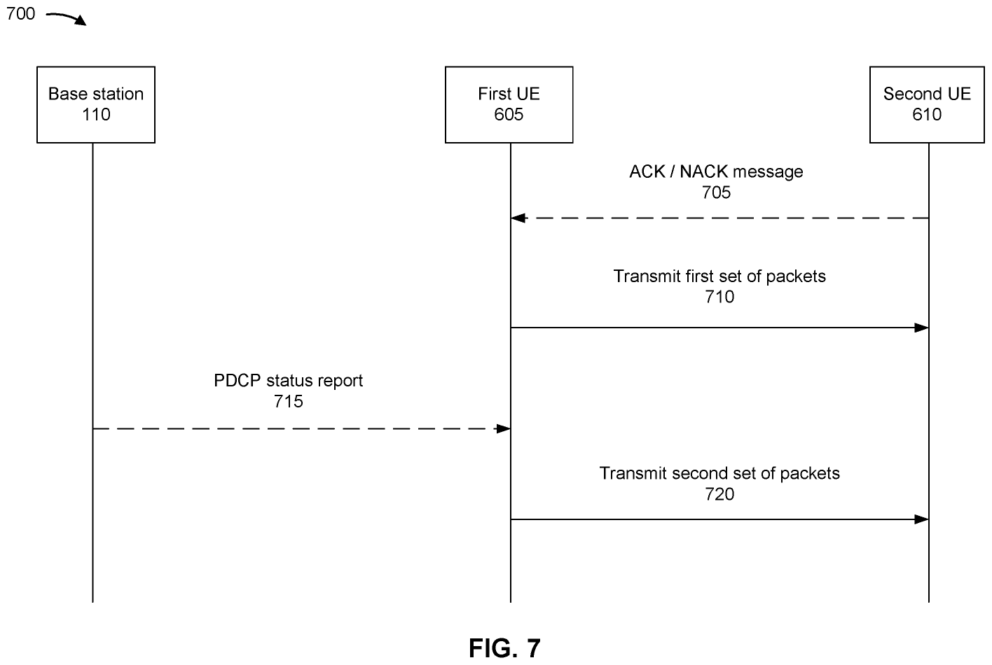

FIG. 7 is a diagram illustrating an example 700 of uplink lossless transmission, in accordance with the present disclosure. A first UE, such as the first UE 605, may communicate with a second UE, such as the second UE 610. The first UE 605 and/or the second UE 610 may include some or all of the features of the UE 120. The first UE 605 and/or the second UE 610 may communicate with a base station, such as the base station 110.

As shown in connection with reference number 705, the second UE 610 may transmit, and the first UE 605 may receive, an acknowledgement message associated with a communication. The acknowledgement message may be a lower layer acknowledgement message indicating that one or more packets were not received from a prior transmission of the packet.

As described above, the first UE 605 may have transmitted a prior communication that included packets 1, 2, 3, 4, 5, and 6. The second UE 610 may have received packets 1, 2, 3, 5, and 6. Packet 4 may have been lost, corrupted, or otherwise dropped during the transmission from the first UE 605 to the second UE 610. The second UE 610 may transmit an acknowledgement message, such as an ACK message indicating that packets 1, 2, 3, 5, and 6 were received by the second UE 610, or a NACK message indicating that packet 4 was not received by the second UE 610.

As shown in connection with reference number 710, the first UE 605 may transmit, and the second UE 610 may receive, a first set of packets. The first UE 605 may transmit (e.g., retransmit) the first set of packets based at least in part on receiving the acknowledgement message. In the example described above, the first set of packets may include the one or more packets that were not received by the second UE 610 from the prior communication. For example, the first set of packets may include packet 4. Thus, the first UE 605 may be configured to retransmit packet 4.

In some aspects, the transmission of the first set of packets may be performed based at least in part on the PDCP re-establishment procedure, or the PDCP data recovery procedure.

As shown in connection with reference number 715, the base station 110 may transmit, and the first UE 605 may receive, a PDCP status report. As described above, the second UE 610 may transmit a relay communication, to the base station 110, that includes all of the packets that are not in the first set of packets. Thus, second UE 610 may transmit packets 1, 2, 3, 5, and 6 to the base station 110. The base station 110 may transmit, to the first UE 605, a PDCP status report that indicates one or more packets that were received by the base station 110. For example, the PDCP status report may indicate packets 1, 2, and 6.

As shown in connection with reference number 720, the first UE 605 may transmit, and the second UE 610 may receive, a second set of packets. The second set of packets may include one or more of the packets of the prior communication that are not included in the PDCP status report. For example, the PDCP status report may indicate a third set of packets that includes packets 1, 2, and 6. Thus, the second set of packets may include a portion of the packets, or all of the packets, that are not included in the third set of packets.

In some aspects, the second set of packets may include all of the packets, of the plurality of packets, that are not included in the third set of packets. Thus, the second set of packets may include packets 3, 4, 5. The first UE 605 may be configured to retransmit packets 3, 4, 5. In this example, the transmission of the first set of packets, and the transmission of the second set of packets, may include at least one common packet. For example, both the transmission of the first set of packets, and the transmission of the second set of packets, may include packet 4.

In some aspects, the second set of packets may include each packet, of the plurality of packets, that is not included in the first set of packets or the third set of packets. In this example, the first UE 605 will not transmit any packets, in the second set of packets, that were included in the transmission of the first set of packets. Thus, the transmission of the first set of packets, and the second set of packets, may not include a common packet. Since the transmission of the first set of packets included packet 4, the transmission of the second set of packets may include packets 3 and 5.

In some aspects, the transmission of the second set of packets may be performed based at least in part on the PDCP re-establishment procedure, or the PDCP data recovery procedure.

As described above, the first UE 605 may not be able to ensure lossless transmission of a communication during a path switching procedure (e.g., a switch between the Uu and PC5 interfaces). The techniques and apparatuses described herein may enable the first UE 605 to perform a first retransmission of a set of packets that were indicated by the second UE 610 as not being received during the prior communication, and to perform a second retransmission of a set of packets that were indicated by the base station 110 as not being received during the prior communication. Thus, the likelihood of a packet being lost, corrupted, or dropped, is reduced.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with uplink lossless transmission.

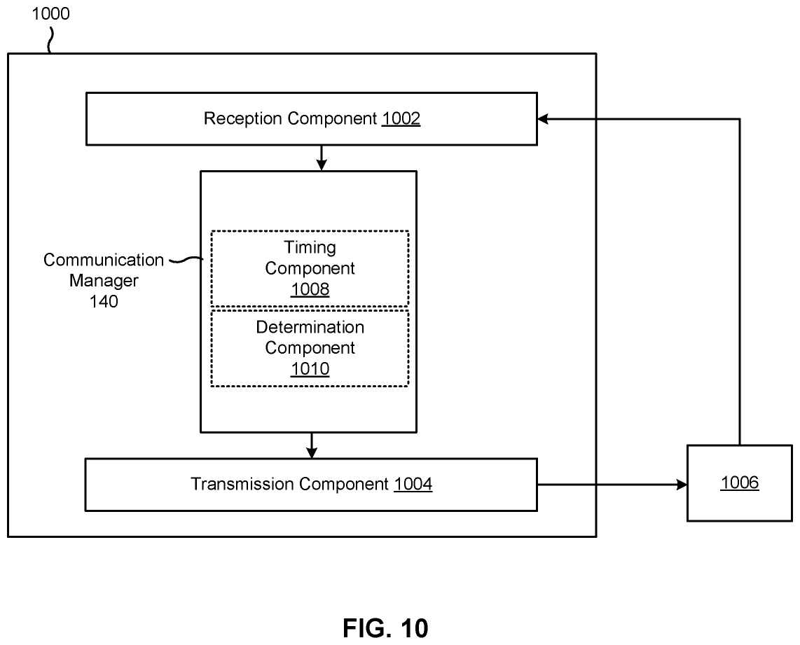

As shown in FIG. 8, in some aspects, process 800 may include receiving an indication to transmit a packet based at least in part on receiving a PDCP status report during an active state of a timer, or based at least in part on an expiration of the timer (block 810). For example, the UE (e.g., using communication manager 140 and/or reception component 1002, depicted in FIG. 10) may receive an indication to transmit a packet based at least in part on receiving a PDCP status report during an active state of a timer, or based at least in part on an expiration of the timer, as described above.

As further shown in FIG. 8, in some aspects, process 800 may include transmitting the packet based at least in part on the indication (block 820). For example, the UE (e.g., using communication manager 140 and/or transmission component 1004, depicted in FIG. 10) may transmit the packet based at least in part on the indication, as described above.

Process 800 may include additional aspects, such as any single aspect or any combination of aspects described below and/or in connection with one or more other processes described elsewhere herein.

In a first aspect, transmitting the packet based at least in part on the indication comprises transmitting the packet during the active state of the timer, if the PDCP status report is received during the active state of the timer, or transmitting the packet based at least in part on the expiration of the timer, if the PDCP status report is not received during the active state of the timer.

In a second aspect, alone or in combination with the first aspect, transmitting the packet based at least in part on the indication comprises transmitting the packet based at least in part on receiving a message, from a second UE, after the expiration of the timer, associated with a prior transmission of the packet.

In a third aspect, alone or in combination with one or more of the first and second aspects, the message is a lower layer acknowledgement message indicating that the packet was not received from the prior transmission.

In a fourth aspect, alone or in combination with one or more of the first through third aspects, process 800 includes initiating the timer based at least in part on receiving the indication.

In a fifth aspect, alone or in combination with one or more of the first through fourth aspects, process 800 includes initiating the timer based at least in part on an initiation of a PDCP re-establishment procedure or a PDCP data recovery procedure.

In a sixth aspect, alone or in combination with one or more of the first through fifth aspects, process 800 includes stopping the timer based at least in part on receiving the PDCP status report.

In a seventh aspect, alone or in combination with one or more of the first through sixth aspects, process 800 includes stopping the timer based at least in part on an initiation of a radio resource control (RRC) re-establishment procedure.

In an eighth aspect, alone or in combination with one or more of the first through seventh aspects, process 800 includes determining that the indication includes one or more errors, and transmitting the packet based at least in part on receiving a lower layer acknowledgement message indicating that the packet was not received from a prior transmission of the packet.

In a ninth aspect, alone or in combination with one or more of the first through eighth aspects, the PDCP status report indicates one or more packets, of a plurality of packets, that have been received, by a base station, from a prior transmission of the plurality of packets.

In a tenth aspect, alone or in combination with one or more of the first through ninth aspects, transmitting the packet comprises transmitting a remainder of the plurality of packets.

In an eleventh aspect, alone or in combination with one or more of the first through tenth aspects, the indication to transmit the packet is received from a base station via an RRC message.

In a twelfth aspect, alone or in combination with one or more of the first through eleventh aspects, the indication to transmit the packet is an indication to retransmit the packet, and wherein transmitting the packet comprises retransmitting the packet.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with the present disclosure. Example process 900 is an example where the UE (e.g., UE 120) performs operations associated with uplink lossless transmission.

As shown in FIG. 9, in some aspects, process 900 may include transmitting a first set of one or more packets, of a plurality of packets, based at least in part on receiving an acknowledgement message (block 910). For example, the UE (e.g., using communication manager 140 and/or transmission component 1004, depicted in FIG. 10) may transmit a first set of one or more packets, of a plurality of packets, based at least in part on receiving an acknowledgement message, as described above.

As further shown in FIG. 9, in some aspects, process 900 may include transmitting a second set of one or more packets, of the plurality of packets, based at least in part on receiving a PDCP status report (block 920). For example, the UE (e.g., using communication manager 140 and/or transmission component 1004, depicted in FIG. 10) may transmit a second set of one or more packets, of the plurality of packets, based at least in part on receiving a PDCP status report, as described above.

Process 900 may include additional aspects, such as any single aspect or any combination of aspects described below and/or in connection with one or more other processes described elsewhere herein.

In a first aspect, the PDCP status report indicates a third set of one or more packets, of the plurality of packets, that were received from a prior transmission of the plurality of packets.

In a second aspect, alone or in combination with the first aspect, the second set of packets includes each packet, of the plurality of packets, that is not included in the third set of packets.

In a third aspect, alone or in combination with one or more of the first and second aspects, the second set of packets includes at least one packet that is included in the first set of packets.

In a fourth aspect, alone or in combination with one or more of the first through third aspects, the second set of packets includes each packet, of the plurality of packets, that is not included in the first set of packets or the third set of packets.

In a fifth aspect, alone or in combination with one or more of the first through fourth aspects, the transmitting the first set of one or more packets, and the transmitting the second set of one or more packets, are performed based at least in part on a PDCP re-establishment procedure or a PDCP data recovery procedure.

In a sixth aspect, alone or in combination with one or more of the first through fifth aspects, the acknowledgement message is a lower layer acknowledgement message indicating that the packet was not received from a prior transmission of the packet.

In a seventh aspect, alone or in combination with one or more of the first through sixth aspects, the transmitting the first set of one or more packets includes retransmitting the first set of one or more packets, and the transmitting the second set of one or more packets includes retransmitting the second set of one or more packets.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include one or more of a timing component 1008, or a determination component 1010, among other examples.

In some aspects, the apparatus 1000 may be configured to perform one or more operations described herein in connection with FIGS. 6-7. Additionally, or alternatively, the apparatus 1000 may be configured to perform one or more processes described herein, such as process 800 of FIG. 8, process 900 of FIG. 9, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive an indication to transmit a packet based at least in part on receiving a PDCP status report during an active state of a timer, or based at least in part on an expiration of the timer. The transmission component 1004 may transmit the packet based at least in part on the indication.

The timing component 1008 may initiate the timer based at least in part on receiving the indication.

The timing component 1008 may initiate the timer based at least in part on an initiation of a PDCP re-establishment procedure or a PDCP data recovery procedure.

The timing component 1008 may stop the timer based at least in part on receiving the PDCP status report.

The timing component 1008 may stop the timer based at least in part on an initiation of an RRC re-establishment procedure.

The determination component 1010 may determine that the indication includes one or more errors.

The transmission component 1004 may transmit the packet based at least in part on receiving a lower layer acknowledgement message indicating that the packet was not received from a prior transmission of the packet.

The transmission component 1004 may transmit a first set of one or more packets, of a plurality of packets, based at least in part on receiving an acknowledgement message. The transmission component 1004 may transmit a second set of one or more packets, of the plurality of packets, based at least in part on receiving a PDCP status report.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a user equipment (UE), comprising: receiving an indication to transmit a packet based at least in part on receiving a packet data convergence protocol (PDCP) status report during an active state of a timer, or based at least in part on an expiration of the timer; and transmitting the packet based at least in part on the indication.

Aspect 2: The method of Aspect 1, wherein transmitting the packet based at least in part on the indication comprises transmitting the packet during the active state of the timer, if the PDCP status report is received during the active state of the timer, or transmitting the packet based at least in part on the expiration of the timer, if the PDCP status report is not received during the active state of the timer.

Aspect 3: The method of any of Aspects 1-2, wherein transmitting the packet based at least in part on the indication comprises transmitting the packet based at least in part on receiving a message, from a second UE, after the expiration of the timer, associated with a prior transmission of the packet.

Aspect 4: The method of Aspect 3, wherein the message is a lower layer acknowledgement message indicating that the packet was not received from the prior transmission.

Aspect 5: The method of any of Aspects 1-4, further comprising initiating the timer based at least in part on receiving the indication.

Aspect 6: The method of any of Aspects 1-5, further comprising initiating the timer based at least in part on an initiation of a PDCP re-establishment procedure or a PDCP data recovery procedure.

Aspect 7: The method of any of Aspects 1-6, further comprising stopping the timer based at least in part on receiving the PDCP status report.

Aspect 8: The method of any of Aspects 1-7, further comprising stopping the timer based at least in part on an initiation of a radio resource control (RRC) re-establishment procedure.

Aspect 9: The method of any of Aspects 1-8, further comprising: determining that the indication includes one or more errors; and transmitting the packet based at least in part on receiving a lower layer acknowledgement message indicating that the packet was not received from a prior transmission of the packet.

Aspect 10: The method of any of Aspects 1-9, wherein the PDCP status report indicates one or more packets, of a plurality of packets, that have been received, by a base station, from a prior transmission of the plurality of packets.

Aspect 11: The method of Aspect 10, wherein transmitting the packet comprises transmitting a remainder of the plurality of packets.

Aspect 12: The method of any of Aspects 1-11, wherein the indication to transmit the packet is received from a base station via a radio resource control (RRC) message.

Aspect 13: The method of any of Aspects 1-12, wherein the indication to transmit the packet is an indication to retransmit the packet, and wherein transmitting the packet comprises retransmitting the packet.

Aspect 14: A method of wireless communication performed by a user equipment (UE), comprising: transmitting a first set of one or more packets, of a plurality of packets, based at least in part on receiving an acknowledgement message; and transmitting a second set of one or more packets, of the plurality of packets, based at least in part on receiving a packet data convergence protocol (PDCP) status report.

Aspect 15: The method of Aspect 14, wherein the PDCP status report indicates a third set of one or more packets, of the plurality of packets, that were received from a prior transmission of the plurality of packets.

Aspect 16: The method of Aspect 15, wherein the second set of packets includes each packet, of the plurality of packets, that is not included in the third set of packets.

Aspect 17: The method of Aspect 16, wherein the second set of packets includes at least one packet that is included in the first set of packets.

Aspect 18: The method of Aspect 15, wherein the second set of packets includes each packet, of the plurality of packets, that is not included in the first set of packets or the third set of packets.

Aspect 19: The method of any of Aspects 14-18, wherein the transmitting the first set of one or more packets, and the transmitting the second set of one or more packets, are performed based at least in part on a PDCP re-establishment procedure or a PDCP data recovery procedure.

Aspect 20: The method of any of Aspects 14-19, wherein the acknowledgement message is a lower layer acknowledgement message indicating that the packet was not received from a prior transmission of the packet.

Aspect 21: The method of any of Aspects 14-20, wherein the transmitting the first set of one or more packets includes retransmitting the first set of one or more packets, and the transmitting the second set of one or more packets includes retransmitting the second set of one or more packets.

Aspect 22: An apparatus for wireless communication at a device, comprising a processor; memory coupled with the processor; and instructions stored in the memory and executable by the processor to cause the apparatus to perform the method of one or more of Aspects 1-13.

Aspect 23: A device for wireless communication, comprising a memory and one or more processors coupled to the memory, the one or more processors configured to perform the method of one or more of Aspects 1-13.

Aspect 24: An apparatus for wireless communication, comprising at least one means for performing the method of one or more of Aspects 1-13.

Aspect 25: A non-transitory computer-readable medium storing code for wireless communication, the code comprising instructions executable by a processor to perform the method of one or more of Aspects 1-13.

Aspect 26: A non-transitory computer-readable medium storing a set of instructions for wireless communication, the set of instructions comprising one or more instructions that, when executed by one or more processors of a device, cause the device to perform the method of one or more of Aspects 1-13.

Aspect 27: An apparatus for wireless communication at a device, comprising a processor; memory coupled with the processor; and instructions stored in the memory and executable by the processor to cause the apparatus to perform the method of one or more of Aspects 14-21.

Aspect 28: A device for wireless communication, comprising a memory and one or more processors coupled to the memory, the one or more processors configured to perform the method of one or more of Aspects 14-21.

Aspect 29: An apparatus for wireless communication, comprising at least one means for performing the method of one or more of Aspects 14-21.

Aspect 30: A non-transitory computer-readable medium storing code for wireless communication, the code comprising instructions executable by a processor to perform the method of one or more of Aspects 14-21.

Aspect 31: A non-transitory computer-readable medium storing a set of instructions for wireless communication, the set of instructions comprising one or more instructions that, when executed by one or more processors of a device, cause the device to perform the method of one or more of Aspects 14-21.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive an indication to transmit a packet based at least in part on receiving a packet data convergence protocol (PDCP) status report during an active state of a timer, or based at least in part on an expiration of the timer; and
transmit the packet based at least in part on the indication.

2. The apparatus of claim 1, wherein the one or more processors are configured to transmit the packet during the active state of the timer, if the PDCP status report is received during the active state of the timer, or transmitting the packet based at least in part on the expiration of the timer, if the PDCP status report is not received during the active state of the timer.

3. The apparatus of claim 1, wherein the one or more processors are configured to transmit the packet based at least in part on receiving a message, from a second UE, after the expiration of the timer, associated with a prior transmission of the packet.

4. The apparatus of claim 3, wherein the message is a lower layer acknowledgement message indicating that the packet was not received from the prior transmission.

5. The apparatus of claim 1, wherein the one or more processors are further configured to initiate the timer based at least in part on receiving the indication.

6. The apparatus of claim 1, wherein the one or more processors are further configured to initiate the timer based at least in part on an initiation of a PDCP re-establishment procedure or a PDCP data recovery procedure.

7. The apparatus of claim 1, wherein the one or more processors are further configured to stop the timer based at least in part on receiving the PDCP status report.

8. The apparatus of claim 1, wherein the one or more processors are further configured to stop the timer based at least in part on an initiation of a radio resource control (RRC) re-establishment procedure.

9. The apparatus of claim 1, wherein the one or more processors are further configured to:
determine that the indication includes one or more errors; and
transmit the packet based at least in part on receiving a lower layer acknowledgement message indicating that the packet was not received from a prior transmission of the packet.

10. The apparatus of claim 1, wherein the PDCP status report indicates one or more packets, of a plurality of packets, that have been received, by a base station, from a prior transmission of the plurality of packets.

11. The apparatus of claim 10, wherein the one or more processors are configured to transmit a remainder of the plurality of packets.

12. The apparatus of claim 1, wherein the indication to transmit the packet is received from a base station via a radio resource control (RRC) message.

13. The apparatus of claim 1, wherein the indication to transmit the packet is an indication to retransmit the packet, and wherein transmitting the packet comprises retransmitting the packet.

14. An apparatus for wireless communication at a user equipment (UE), comprising:
a memory; and
one or more processors, coupled to the memory, configured to:
transmit a first set of one or more packets, of a plurality of packets, based at least in part on receiving an acknowledgement message; and
transmit a second set of one or more packets, of the plurality of packets, based at least in part on receiving a packet data convergence protocol (PDCP) status report.

15. The apparatus of claim 14, wherein the PDCP status report indicates a third set of one or more packets, of the plurality of packets, that were received from a prior transmission of the plurality of packets.

16. The apparatus of claim 15, wherein the second set of packets includes each packet, of the plurality of packets, that is not included in the third set of packets.

17. The apparatus of claim 16, wherein the second set of packets includes at least one packet that is included in the first set of packets.

18. The apparatus of claim 15, wherein the second set of packets includes each packet, of the plurality of packets, that is not included in the first set of packets or the third set of packets.

19. The apparatus of claim 14, wherein the transmitting the first set of one or more packets, and the transmitting the second set of one or more packets, are performed based at least in part on a PDCP re-establishment procedure or a PDCP data recovery procedure.

20. The apparatus of claim 14, wherein the acknowledgement message is a lower layer acknowledgement message indicating that the packet was not received from a prior transmission of the packet.

21. The apparatus of claim 14, wherein the transmitting the first set of one or more packets includes retransmitting the first set of one or more packets, and the transmitting the second set of one or more packets includes retransmitting the second set of one or more packets.

22. A method of wireless communication performed by a user equipment (UE), comprising:
receiving an indication to transmit a packet based at least in part on receiving a packet data convergence protocol (PDCP) status report during an active state of a timer, or based at least in part on an expiration of the timer; and
transmitting the packet based at least in part on the indication.

23. The method of claim 22, wherein transmitting the packet based at least in part on the indication comprises transmitting the packet during the active state of the timer, if the PDCP status report is received during the active state of the timer, or transmitting the packet based at least in part on the expiration of the timer, if the PDCP status report is not received during the active state of the timer.

24. The method of claim 22, wherein transmitting the packet based at least in part on the indication comprises transmitting the packet based at least in part on receiving a message, from a second UE, after the expiration of the timer, associated with a prior transmission of the packet.

25. The method of claim 22, wherein the PDCP status report indicates one or more packets, of a plurality of packets, that have been received, by a base station, from a prior transmission of the plurality of packets.

26. A method of wireless communication performed by a user equipment (UE), comprising:
transmitting a first set of one or more packets, of a plurality of packets, based at least in part on receiving an acknowledgement message; and
transmitting a second set of one or more packets, of the plurality of packets, based at least in part on receiving a packet data convergence protocol (PDCP) status report.

27. The method of claim 26, wherein the PDCP status report indicates a third set of one or more packets, of the plurality of packets, that were received from a prior transmission of the plurality of packets.

28. The method of claim 27, wherein the second set of packets includes each packet, of the plurality of packets, that is not included in the third set of packets.

29. The method of claim 28, wherein the second set of packets includes at least one packet that is included in the first set of packets.

30. The method of claim 27, wherein the second set of packets includes each packet, of the plurality of packets, that is not included in the first set of packets or the third set of packets.
